(19) United States
(12) Patent Application Publication
(10) Pub. No.: US 2011/0093882 A1
(43) Pub. Date: Apr. 21, 2011

(54) Parental control through the HDMI interface

(76) Inventors: Brant L. Candelore, San Diego, CA (US); Peter Rae Shintani, San Diego, CA (US)

(21) Appl. No.: 12/589,275

(22) Filed: Oct. 21, 2009

(51) Int. Cl. H04N 7/16; H04N 7/00

(52) U.S. Cl. 725/28; 348/468

(57) ABSTRACT

An HDMI parental control device consistent with certain embodiments has an HDMI receiver that receives an HDMI audio/video stream and produces editable audio/video output data and a logic processor that receives closed caption data and compares descriptors in the closed caption data with a list of descriptors to be censored. When the logic processor detects a descriptor to be censored it causes the audio/video data corresponding to the descriptor to be censored to be altered from the audio/video output data to produce censored audio/video output data and uncensored audio/video output data and then output via an HDMI transmitter. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

In analog television, the video blanking interval (VBI) was used to carry parental control information. One example is the TV Guardian product which uses line 21 closed caption data to detect and filter undesired content. However, the inventors have noted that there is no direct equivalent when HDMI (High Definition Multimedia Interface) connections are used and no protocol for carrying V-chip type information.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an example external parental control box consistent with certain embodiments of the present invention.

FIG. 2 is a system block diagram of an example external parental control box within a TV system consistent with certain embodiments of the present invention.

FIG. 3 is an example flow chart of a process for censoring TV audio in a manner consistent with certain embodiments of the present invention.

FIG. 4 is an example flow chart of a process for censoring TV audio and/or video in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “processor”, “controller”, “CPU”, “Computer” and the like as used herein encompasses both hard programmed, special purpose, general purpose and programmable devices and may encompass a plurality of such devices or a single device in either a distributed or centralized configuration without limitation.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The so-called “V-chip” has been used to provide a degree of parental control to censor the television viewing experience under control of the parent. However, the V-chip approach does not provide for all circumstances in home entertainment arrangements using HDMI connections for a television set.

“Open” captioning is captioning that has been decoded and rendered into the video. “Closed” captioning has not been decoded yet. It may be delivered as data in analog signals with “line 21” or through other means. It may also be delivered through other means. The invention anticipates that it will be delivered through one of the signals of the HDMI connector although there could be other signaling such as through a USB interface.

The HDMI interface is evolving over time. eHDMI is an enhanced HDMI connection to repurpose a reserve line to provide Ethernet capability. The term HDMI as used herein also includes eHDMI.

In accord with certain implementations, an external parental control box is used in between, for example, a television set-top box or video disk player and a display device to enable word-by-word or scene-by-scene control over the content. A number of embodiments are envisioned. In the illustrated example cases, the following scenarios are true: 1) HDMI is output from the set-top box for input into the external parental control box, and 2) HDMI is output from the external parental control box for input into a television or other display device. Content is HDCP (High-Bandwidth Digital Copy Protection) protected from the set-top box to external parental control box and from the external parental control box to display device. If the captioning is not already being decoder by the source device as “open” captioning in the HDMI video data, then the captioning can be decoded (and censored) by the external parental control box. Otherwise, the external parental control box can alter objectionable content in the open captioning.

Preferably, the clear audio/video bits, received by the control box, is modified for muting or substitution purposes. Ideally, this would require the content to be decrypted and essentially rendered in a buffer. Substitute content can be applied first—overlaid on the video data. In the case of audio, the L-PCM audio and AC-3 audio would be rendered and modified as needed. If the control box is enabled to display captioning, the decoded captioning or substitute captioning would be overlaid on the video data. After the modification, the video and audio data would be re-encoded into HDMI and sent to the target display. Two HDCP sessions are used—one from program source to the external parental control box, and one from the external parental control to display device. The parental control box is consistent with an HDCP repeater.

It may be possible to operate on encrypted content, but the representation on screen or through the speakers may be unpredictable, e.g. with multi-colored macroblocks rendered on screen and uncontrollable “popping” sound. And while “pass-through” content could theoretically use the same HDCP session, since it is unmodified content, it is time consuming to establish a HDCP session when needed on-the-fly. Consequently, it is anticipated, that all content regardless of whether or not it is been altered would be decrypted from the program source and re-encrypted for delivery to the display. The control box is a HDCP repeater.

Descriptive closed captioning or other signaling may allow video and not just audio to be muted or substituted. This can allow situations where only the video is altered, both the video and audio, or just the audio gets altered.

Unfortunately, it may not be possible to prevent the program source from decoding captioning and this can conflict with the decoding and alterations made by the control box. The decoded caption is rendered as text in the video stream through the HDMI connector—what we refer to as “open captioning”. As mentioned previously, this can occur at the same time that closed captioning is delivered via other means as described in more detail below. This closed captioning can help the external parental control box determine that open captioning exists and approximately where in the video stream it is located since the closed captioning has default on-screen location or can specify an alternative location. However, in the worst case scenario, there is open captioning rendered by the program and there is no closed captioning at all. This requires the external parental control box to detect the presence of the open closed captioning information in the first place, e.g. by detecting a rectangular box with text that could be rendered anywhere on-screen. It then should interpret the text through an On-screen Character Recognition (OCR) process. The text must be analyzed and then overwritten if need be when objectionable content is present that can be filtered. In all cases, the “substitute” text could be blank. The parental control box must then decide whether or not to alter the audio and/or the video as well.

A number of embodiments are possible and several are disclosed, but other embodiments are possible without departing from the present invention. Embodiment 1) Passing, muting or substituting HDMI content through the external parental control box is conditioned on closed captioning data sent out the analog port or RF output of the set-top box. The external parental control box in this instance has 2 inputs—RF channel 3/4 or analog video (with line 21 data), and HDMI.

Embodiment 2) Passing, muting or substituting HDMI content through external parental control box is conditioned on closed captioning data sent in packets with the HDMI content (same connector)—whereby either a. the closed captioning data (delivered with the A/V content in the same connector) is delivered via I2C or via CEC (consumer electronics control) or Ethernet (with eHDMI). In cases above, closed captioning data are sent with HDMI A/V). As mentioned previously, the closed captioning could be sent using a different interface altogether, e.g. USB. And it is even possible to send closed captioning as A/V, bits which might get innocuously rendered on-screen or through the speakers; and

Embodiment 3) Passing, muting or substituting HDMI content is through external parental control box where captioning is “open” overlaid on the content and sent as HDMI video. In this scenario there is no closed captioning information sent. And so this is the “worst case”. The content must be decrypted, the open captioning located, analyzed and modified if need be along with the audio and video content, and then re-encrypted to be sent to the display device.

Use of embodiments consistent with the present invention can facilitate selective blocking and/or substitution of digital content when the blocking is not integrated in the source, e.g. set-top box, or the display device, e.g. TV.

In one embodiment, the closed captioning data are obtained as before from a source of analog output, but then applied to the source digital HDMI output. In another embodiment closed caption (CC) data are output through the HDMI connector via any suitable signal lines (e.g., I2C, CEC, Ethernet). The CC may also be available through a USB interface or sent as A/V bits. This data may also be rendered as innocuous video or audio. In another embodiment, CC data is output as “open” captioning in the video sent through the HDMI connector.

The external parental control box should preferably be flexible to the extent that it can utilize the best communication method available on the particular HDMI connection to the unit. Hence, if CEC in the sink device can support the adapter's protocol, CEC messaging could be used, or if not available, I2C could be used. In the case of I2C, MCCS could be used as a protocol or if not supported, more proprietary I2C commands could be used, and so on.

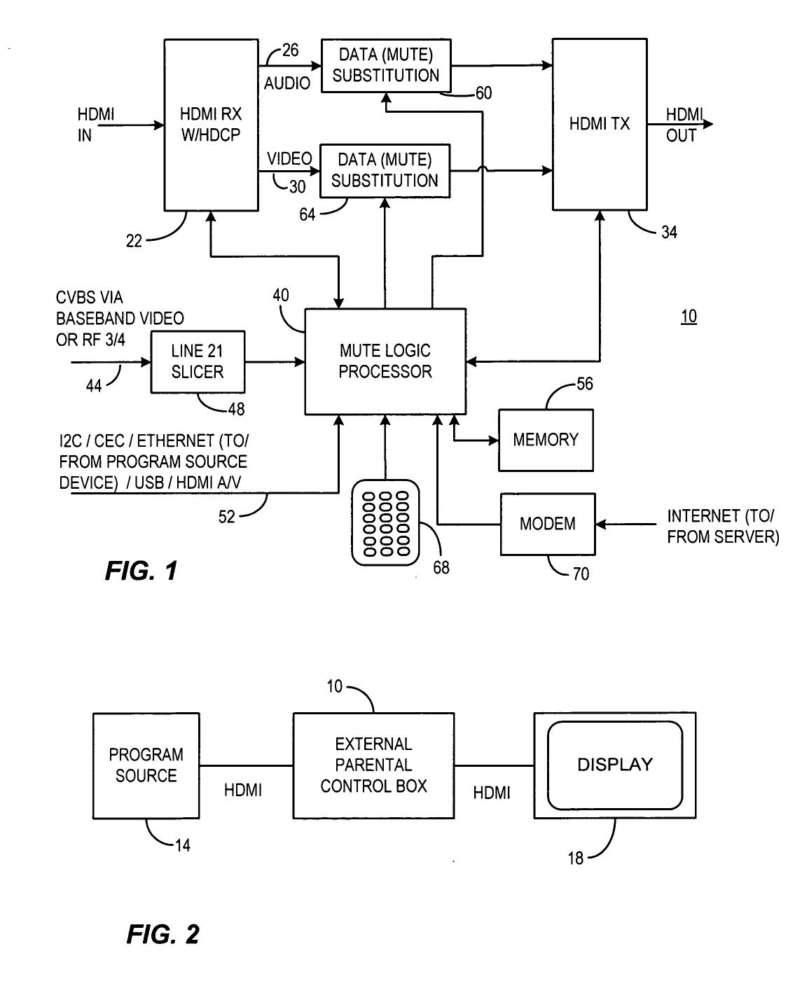

The present invention is best understood by reference to an example implementation depicted for example in FIG. 1, where the external parental control box 10 is generally depicted. This external parental control box 10 is inserted between a program source 14 and a display device such as a TV set 18 as depicted in FIG. 2.

In the embodiment depicted, the external parental control box 10 receives HDMI signals from source 14 at an input receiver (i.e., a commercially available HDMI receiver chip) 22, which is HDCP enabled to produce output audio and video packets (shown separately as 26 and 30 for clarity). These audio and video packets, under normal circumstances, are passed along to an output HDMI transmitter circuit 34 (e.g., such as those which are commercially available) to produce output HDMI signals for the display device 18. Audio at 26 may be in the form of L-PCM, AC3, I2S or any other suitable format. Video may be in the form of 24 bit video data or other format without limitation.

A control processor 40, such as a microcomputer or microcontroller or hardwired programmable logic device, oversees operation of the external parental control box 10 and in addition receives closed captioning information via any number of sources (many of which are illustrated in this figure, but all may not be present in all implementations). In one instance, CVBS data at line 44 (composite video baseband signal or RF 3/4 input) can be used to receive line 21 closed captioning data at a line 21 slicer 48 to determine from the closed CC information whether there is content that is to be filtered under parental control instructions.

In another instance, the CC information is digitally encoded in, for example, HDMI packets received via receiver 22 and passed to mute logic processor 40, or via any of an USB, HDMI A/V (which has been repurposed to convey CC), I2C, CEC, or Ethernet (using eHDMI from the program source device) communication line 52 at the processor 40 (via a suitable interface not shown). Processor 40 also utilizes memory 56 which can represent RAM, as well as persistent storage used to store programming instructions as well as substitution information, as will become clear upon further consideration of the present teachings.

In order to effect a substitution of an acceptable word in place of an unacceptable word, for example, the processor 40 detects CC data representing a word to be filtered and looks up the word in memory to find either an acceptable substitute or mute data which is substituted in the data stream using audio data substitution 60 or video data substitution 64. Substitution could be “silence” and a “blank screen”. In certain implementations, for example, the serial video from the HDMI receiver is rendered in memory and the area that contains the closed caption or subtitle can be detected or located via the closed captioning data (obtained from a different path), and then substituted. The modified video can then be read out from memory serially and sent to the HDMI transmitter 34. Other methods could also be used to implement the substitution. A user interface such as a keypad 68 can be used to enter passwords and otherwise control operation of the external parental control box 10. Data can be downloaded to the external parental control box 10 via the Internet using modem 70 or can be uploaded from disc media or flash memory in other embodiments.

In this external parental control box 10, content substitution is used to replace CC information as well as substitution or muting of speech signals. Thus, for example, if it is desired to substitute “darn” in place of the more offensive “damn”, the presence of the word is detected in the CC data and the corresponding speech can be altered by muting or replacement of the word by modifying the digital audio bits in the HDMI packets.

It will be understood that data can be downloaded to the external parental control box 10 via the Internet or can be uploaded from disc media or flash memory. Such data, as will be seen, can be specific to the program material being viewed on the TV—be it disc content or content from a cable or satellite system, or other source of television programming or movies. The description data sent with the captioning can tag the video content of a scene as discussed below. In addition, a scene can be identified using a serial number. The serial number can be used to index into the uploaded content to find the appropriate substitute content for a particular program. The description data (including the serial number) can be used by the control box to alter the content, and if alternate content is available, substitute it.

Video filtering can be accomplished by use of data sent with captioning data.

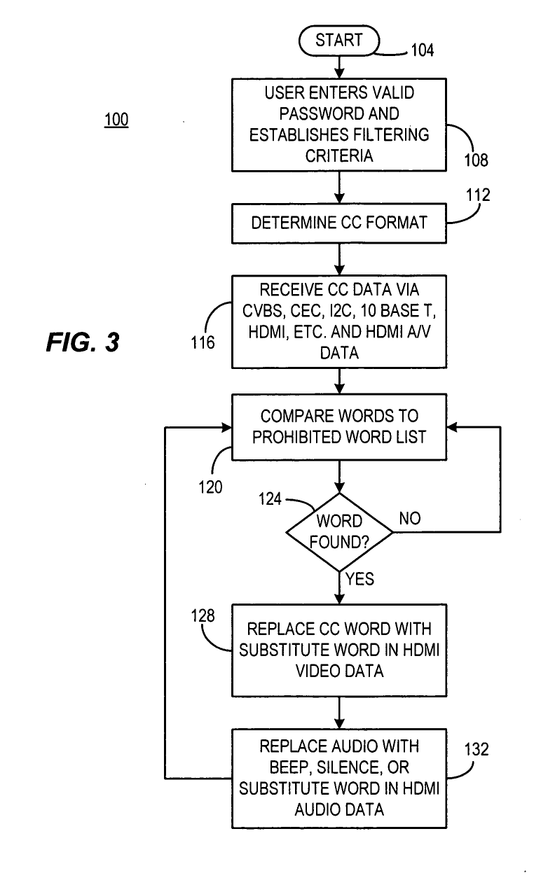

With reference to FIG. 3, an example audio filtering process 100 is depicted starting at 104 wherein the user enters a valid password at keypad or other user interface 68 at 108. Use of a password is optional, however. The user can then select filtering criteria that establishes, for example, what type of censoring is to be carried out by the external parental control box 10. For example, with various categories of filtering can be selected via a menu produced on the video display 18 such as filtering for foul language, sexual language, drug related language, violent language, slang words, blasphemy or other content that might be objectionable to the user in charge of the filtering. In other implementations, the user can be presented with a list of words that can be selected for filtering. Any other mechanism that selects words or categories of words can be used to provide the filtering in a manner consistent with embodiments of the present invention.

The system then determines which format of CC data is being used at 112. This generally involves determining if the CC information is displayed using 15 rows by 32 columns or 15 rows by 40 columns. This information is obtained so that words within the CC data can be inconspicuously replaced with pixel for pixel replacements.

Data are then received at 116 including HDMI video and audio along with CC data via whatever mechanism such data are available (e.g., CVBS, CEC, I2C, Ethernet or HDMI A/V encoding of the CC data). At this point, at 120, the CC data (descriptors for video scenes or words) are compared with the selections of prohibited data (descriptors for video scenes or words) selected at 108 either by virtue of descriptor for descriptor selection or selection of categories of descriptors or any other mechanism. If a descriptor is not found at 124, the comparison continues until a descriptor is found that matches a descriptor selected for censorship. When a word is found, it is optionally censored in the closed caption data by a substitute descriptor (video description or word) so that the story line can be retained in CC form at 128. Most people don't chose to watch captioning on screen. Consequently, the substitution of caption that is visible on screen would only be if enabled by the viewer. The video scene or location of the word in the audio is also censored at 132 by either substitution of a substitute scene, blanking, word, beep, silence or other censor function. Once this substitution is complete, the process resumes from 120.

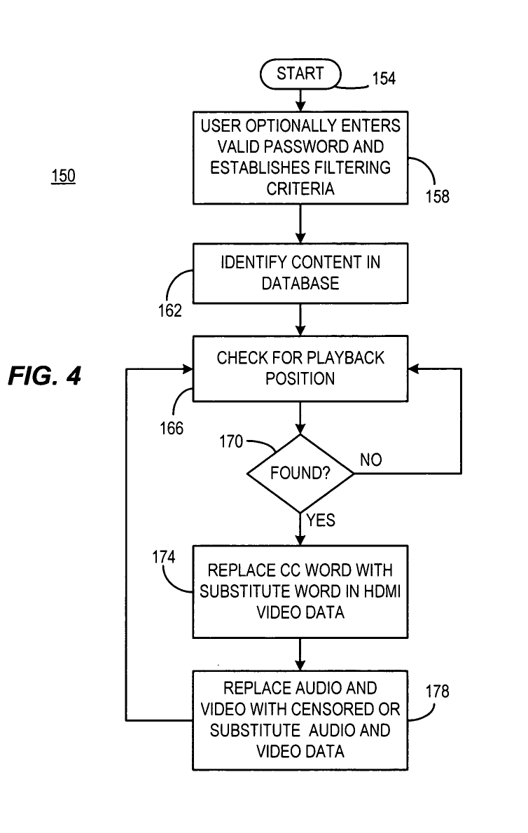

Video and/or audio can be censored in another manner according to the process of FIG. 4 depicted as 150 starting at 154. At 158, the user enters a search criterion which may be specific to a particular program or movie. Such filters can be individualized for a particular program or movie and stored in memory 56 (which can be updated by Internet access, subscription or other mechanism. In this technique, various categories of objectionable content are cataloged in a database for each program or movie, so that when a particular scene or word is encountered, its timing is known by virtue of the database. Hence, the content being played is identified in the database at 162 and the objectionable content as defined or categorized by the user's selection. Such categories are translated to particular words or scenes that appear at particular times in the program presentation and can be readily censored by substitution, removal of the scene, or blanking out or blurring the video at a particular location, etc.

Hence, the playback position is continually monitored for the current program at 166 until a position with objectionable material is identified at 170. At this point, the CC data are replaced with a substitute word or the word blanked out at 174. At 178, the audio and/or video are censored or substitute audio and/or video are inserted.

All insertion of substitute content is done in the embodiments above using the mute data substitution blocks 60 and 64, where the term mute is used for convenience in that the objectionable material is muted, even though a substitution may actually be carried out rather than a simple literal muting.

Thus, in accord with certain embodiments, an HDMI parental control device has an HDMI receiver that receives an HDMI audio/video stream and produces editable audio/video output data. A logic processor receives closed caption data and compares descriptors in the closed caption data with a list of descriptors to be censored. When the logic processor detects a descriptor to be censored in the closed caption data, the logic processor causes the audio/video data corresponding to the descriptor to be censored to be altered from the audio/video output data to produce censored audio/video output data and uncensored audio/video output data. An HDMI transmitter receives the censored audio/video output data and the uncensored audio/video output data and converts the censored audio/video output data and the uncensored audio/video output data to an HDMI output stream. A user interface allows a user to select descriptors or categories of descriptors that are to be censored. A memory stores descriptors to be censored as a prohibited descriptor list.

In certain implementations, the closed caption data are received via one of analog baseband video, RF 3 or 4, I2C interface, CEC interface, Ethernet interface, USB interface, and repurposed HDMI A/V data.

An HDMI parental control device consistent with certain implementations has an HDMI receiver that receives an HDMI audio/video stream and produces editable audio and video output data. A logic processor receives closed caption data and compares words in the closed caption data with a list of words to be censored. When the logic processor detects a word to be censored in the closed caption data, the logic processor causes the word to be censored to be removed or substituted in the closed caption data to produce censored closed caption data. The logic processor further causes the word to be censored to be removed from the audio output data to produce censored audio output data. An HDMI transmitter receives the censored audio data and the video data and the censored closed caption data and converts the censored audio data and the video data and the censored closed caption data to an HDMI output stream. The closed caption data are received from at least one of a line 21 slicer that receives CVBS closed caption data, an I2C interface, a CEC interface, and an Ethernet interface. A user interface allows a user to select words or categories of words that are to be censored. A memory stores words to be censored as a prohibited word list.

Another HDMI parental control device has an HDMI receiver that receives an HDMI audio/video stream and produces editable audio/video output data. A logic processor receives closed caption data and compares descriptors in the closed caption data with a list of descriptors to be censored. When the logic processor detects a descriptor to be censored in the closed caption data, the logic processor causes the audio/video data corresponding to the descriptor to be censored to be altered from the audio/video output data to produce censored audio/video output data and uncensored audio/video output data. An HDMI transmitter receives the censored audio/video output data and the uncensored audio/video output data and converts the censored audio/video output data and the uncensored audio/video output data to an HDMI output stream.

In certain implementations, the logic processor receives open caption data corresponding to the closed caption data, the open caption data being represented in the video output data; and the logic processor detects and analyzes the open caption data and alters the open caption in the video output data corresponding to descriptor to be censored. In certain implementations, the logic processor further decodes the censored closed caption data and modifying the uncensored video output data or censored video output to create modified video output data with open censored closed caption data; and the HDMI transmitter creates the HDMI output stream from the censored audio/video output data, the uncensored audio video output data, and modified video output data with open censored closed caption data.

Another HDMI parental control device has an HDMI receiver that receives an HDMI audio/video signal stream and produces editable audio and video output data;

a logic processor that receives closed caption data and compares words in the closed caption data with a list of words to be censored. When the logic processor detects a word to be censored in the closed caption data, the logic processor causes the word to be censored to be removed from the closed caption data to produce censored closed caption data. The logic processor further causes the word to be censored to be removed from the audio output data to produce censored audio output data. An HDMI transmitter receives the censored audio data and the video data and the censored closed caption data and converts the censored audio data and the video data and the censored closed caption data to an HDMI output stream.

In certain implementations, a line 21 slicer receives CVBS closed caption data and provides the closed caption data to the logic processor. In certain implementations, the closed caption data are received via one of an I2C interface, CEC interface, Ethernet interface, USB interface, and repurposed HDMI A/V data. In certain implementations, the closed caption data are received via an I2C interface. In certain implementations, the closed caption data are received via a CEC interface. In certain implementations, the closed caption data are received via an Ethernet interface. In certain implementations, a user interface allows entry of a password that provides access to parental control settings. In certain implementations, a user interface provides for a user to select words or categories of descriptors that are used as the descriptors to be censored. In certain implementations, descriptors to be censored are stored in a memory as a prohibited descriptors list. In certain implementations, the words to be censored are replaced with acceptable words. In certain implementations, the words to be censored are muted or replaced with a censoring sound.

Another HDMI parental control device has an HDMI receiver that receives an HDMI audio/video signal stream and produces editable audio and video output data. A logic processor receives and stores a database of scenes and words to be censored in a memory. When the logic processor detects a word to be censored in the open caption data, the logic processor causes the word to be censored to be removed from the open caption data to produce censored closed caption data. The logic processor further causes the word to be censored to be removed from the audio output data to produce censored audio output data. The logic processor further causes the scenes to be censored to be censored in the video output data, an HDMI transmitter receives the censored audio data and the video data and the censored closed caption data and converts the censored audio data and the video data and the censored closed caption data to an HDMI output stream. The scenes and words to be censored are received via a modem connection to the Internet. A user interface allows entry of a password that provides access to parental control settings and where the user interface further provides for the user to select words or categories of words that are used as the words to be censored. The user interface further provides for the user to select categories of scenes that are to be censored. Words and scenes to be censored are stored in the memory as a prohibited word and scene list with prohibited scenes being defined by start and stop position in a program.

Another HDMI parental control device has an HDMI receiver that receives an HDMI audio/video signal stream and produces editable audio and video output data. A logic processor receives and stores a database of scenes and words to be censored in a memory. When the logic processor detects a word to be censored in the closed caption data, the logic processor causes the word to be censored to be removed from the closed caption data to produce censored closed caption data. The logic processor further causes the word to be censored to be removed from the audio output data to produce censored audio output data. The logic processor further causes the scenes to be censored to be censored in the video output data. An HDMI transmitter receives the censored audio data and the video data and the censored closed caption data and converts the censored audio data and the video data and the censored closed caption data to an HDMI output stream.

In certain implementations, the scenes and words to be censored are received via a modem connection to the Internet. In certain implementations, the scenes and words to be censored are received via a storage medium. In certain implementations, a user interface allows entry of a password that provides access to parental control settings. In certain implementations, the user interface further provides for the user to select words or categories of words that are used as the words to be censored. In certain implementations, the user interface further provides for the user to select categories of scenes that are to be censored. In certain implementations, words and scenes to be censored are stored in memory as a prohibited word and scene list with prohibited scenes being defined by start and stop position in a program.

Another HDMI parental control device has an HDMI receiver that receives an HDMI audio/video stream and produces editable audio and video output data. A logic processor analyzes the video output data for open caption data for words, and compares the words in the closed caption data with a list of words to be censored. When the logic processor detects a word to be censored in the open caption data, the logic processor causes the word to be censored to be removed or substituted in the open caption data represented in the video data to produce censored video data. The logic processor further causes the word to be censored to be removed or substituted from the audio output data to produce censored audio output data. An HDMI transmitter receives the censored audio data and the censored video data and converts the censored audio data and the censored video data to an HDMI output stream.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, microcontrollers, optical computers, analog computers, dedicated processors, application specific circuits and/or dedicated hard wired logic may be used to construct alternative equivalent embodiments.

While certain illustrative embodiments have been described, it is evident that many alternatives, modifications, permutations and variations will become apparent to those skilled in the art in light of the foregoing description.

What is claimed is:

1. An HDMI parental control device, comprising:
an HDMI receiver that receives an HDMI audio/video stream and produces editable audio/video output data;
a logic processor that receives closed caption data and compares descriptors in the closed caption data with a list of descriptors to be censored;
where, when the logic processor detects a descriptor to be censored in the closed caption data, the logic processor causes the audio/video data corresponding to the descriptor to be censored to be altered from the audio/video output data to produce censored audio/video output data and uncensored audio/video output data;
an HDMI transmitter that receives the censored audio/video output data and the uncensored audio/video output data and converts the censored audio/video output data and the uncensored audio/video output data to an HDMI output stream;
a user interface that allows a user to select descriptors or categories of descriptors that are to be censored; and
a memory where descriptors to be censored are stored as a prohibited descriptor list.

2. The HDMI parental control device according to claim 1, where the closed caption data are received via one of analog baseband video, RF 3 or 4, I2C interface, CEC interface, Ethernet interface, USB interface, and repurposed HDMI A/V data.

3. An HDMI parental control device, comprising:
an HDMI receiver that receives an HDMI audio/video stream and produces editable audio and video output data;
a logic processor that receives closed caption data and compares words in the closed caption data with a list of words to be censored;
where, when the logic processor detects a word to be censored in the closed caption data, the logic processor causes the word to be censored to be removed or substituted in the closed caption data to produce censored closed caption data;
where the logic processor further causes the word to be censored to be removed from the audio output data to produce censored audio output data;
an HDMI transmitter that receives the censored audio data and the video data and the censored closed caption data and converts the censored audio data and the video data and the censored closed caption data to an HDMI output stream;
where the closed caption data are received from at least one of a line 21 slicer that receives CVBS closed caption data, an I2C interface, a CEC interface, and an Ethernet interface;
a user interface that allows a user to select words or categories of words that are to be censored; and
a memory where words to be censored are stored as a prohibited word list.

4. An HDMI parental control device, comprising:
an HDMI receiver that receives an HDMI audio/video stream and produces editable audio/video output data;
a logic processor that receives closed caption data and compares descriptors in the closed caption data with a list of descriptors to be censored;
where, when the logic processor detects a descriptor to be censored in the closed caption data, the logic processor causes the audio/video data corresponding to the descriptor to be censored to be altered from the audio/video output data to produce censored audio/video output data and uncensored audio/video output data;
an HDMI transmitter that receives the censored audio/video output data and the uncensored audio/video output data and converts the censored audio/video output data and the uncensored audio/video output data to an HDMI output stream.

5. The HDMI parental control device according to claim 4, wherein the logic processor receives open caption data corresponding to the closed caption data, the open caption data being represented in the video output data; and
where the logic processor detects and analyzes the open caption data and alters the open caption in the video output data corresponding to descriptor to be censored.

6. The HDMI parental control device according to claim 4, wherein the logic processor further decodes the censored closed caption data and modifying the uncensored video output data or censored video output to create modified video output data with open censored closed caption data; and
where the HDMI transmitter creates the HDMI output stream from the censored audio/video output data, the uncensored audio video output data, and modified video output data with open censored closed caption data.

7. An HDMI parental control device, comprising:
an HDMI receiver that receives an HDMI audio/video signal stream and produces editable audio and video output data;
a logic processor that receives closed caption data and compares words in the closed caption data with a list of words to be censored;
where, when the logic processor detects a word to be censored in the closed caption data, the logic processor causes the word to be censored to be removed from the closed caption data to produce censored closed caption data;
where the logic processor further causes the word to be censored to be removed from the audio output data to produce censored audio output data; and
an HDMI transmitter that receives the censored audio data and the video data and the censored closed caption data and converts the censored audio data and the video data and the censored closed caption data to an HDMI output stream.

8. The HDMI parental control device according to claim 7, further comprising a line 21 slicer that receives CVBS closed caption data and provides the closed caption data to the logic processor.

9. The HDMI parental control device according to claim 7, where the closed caption data are received via one of an I2C interface, CEC interface, Ethernet interface, USB interface, and repurposed HDMI A/V data.

10. The HDMI parental control device according to claim 7, where the closed caption data are received via an I2C interface.

11. The HDMI parental control device according to claim 7, where the closed caption data are received via a CEC interface.

12. The HDMI parental control device according to claim 7, where the closed caption data are received via an Ethernet interface.

13. The HDMI parental control device according to claim 7, further comprising a user interface that allows entry of a password that provides access to parental control settings.

14. The HDMI parental control device according to claim 13, where the user interface further provides for the user to select words or categories of descriptors that are used as the descriptors to be censored.

15. The HDMI parental control device according to claim 7, where descriptors to be censored are stored in a memory as a prohibited descriptors list.

16. The HDMI parental control device according to claim 7, wherein the words to be censored are replaced with acceptable words.

17. The HDMI parental control device according to claim 7, wherein the words to be censored are muted or replaced with a censoring sound.

18. An HDMI parental control device, comprising:
an HDMI receiver that receives an HDMI audio/video signal stream and produces editable audio and video output data;
a logic processor that receives and stores a database of scenes and words to be censored in a memory;
where, when the logic processor detects a word to be censored in the open caption data, the logic processor causes the word to be censored to be removed from the open caption data to produce censored closed caption data;
where the logic processor further causes the word to be censored to be removed from the audio output data to produce censored audio output data;
where the logic processor further causes the scenes to be censored to be censored in the video output data;
an HDMI transmitter that receives the censored audio data and the video data and the censored closed caption data and converts the censored audio data and the video data and the censored closed caption data to an HDMI output stream;
a modem, where the scenes and words to be censored are received via a modem connection to the Internet;
a user interface that allows entry of a password that provides access to parental control settings and where the user interface further provides for the user to select words or categories of words that are used as the words to be censored, and where the user interface further provides for the user to select categories of scenes that are to be censored; and
where words and scenes to be censored are stored in the memory as a prohibited word and scene list with prohibited scenes being defined by start and stop position in a program.

19. An HDMI parental control device, comprising:
an HDMI receiver that receives an HDMI audio/video signal stream and produces editable audio and video output data;
a logic processor that receives and stores a database of scenes and words to be censored in a memory;
where, when the logic processor detects a word to be censored in the closed caption data, the logic processor causes the word to be censored to be removed from the closed caption data to produce censored closed caption data;
where the logic processor further causes the word to be censored to be removed from the audio output data to produce censored audio output data;
where the logic processor further causes the scenes to be censored to be censored in the video output data; and
an HDMI transmitter that receives the censored audio data and the video data and the censored closed caption data and converts the censored audio data and the video data and the censored closed caption data to an HDMI output stream.

20. The HDMI parental control device according to claim 19, where the scenes and words to be censored are received via a modem connection to the Internet.

21. The HDMI parental control device according to claim 19, where the scenes and words to be censored are received via a storage medium.

22. The HDMI parental control device according to claim 19, further comprising a user interface that allows entry of a password that provides access to parental control settings.

23. The HDMI parental control device according to claim 19, where the user interface further provides for the user to select words or categories of words that are used as the words to be censored.

24. The HDMI parental control device according to claim 19, where the user interface further provides for the user to select categories of scenes that are to be censored.

25. The HDMI parental control device according to claim 19, where words and scenes to be censored are stored in memory as a prohibited word and scene list with prohibited scenes being defined by start and stop position in a program.

26. An HDMI parental control device, comprising:
an HDMI receiver that receives an HDMI audio/video stream and produces editable audio and video output data;
a logic processor that analyzes the video output data for open caption data for words, and compares the words in the closed caption data with a list of words to be censored;
where, when the logic processor detects a word to be censored in the open caption data, the logic processor causes the word to be censored to be removed or substituted in the open caption data represented in the video data to produce censored video data;
where the logic processor further causes the word to be censored to be removed or substituted from the audio output data to produce censored audio output data; and
an HDMI transmitter that receives the censored audio data and the censored video data and converts the censored audio data and the censored video data to an HDMI output stream.
